(19) United States
(12) Patent Application Publication
(10) Pub. No.: US 2010/0158033 A1
(43) Pub. Date: Jun. 24, 2010

(54) COMMUNICATION APPARATUS IN LABEL SWITCHING NETWORK

(75) Inventor: Masatake Miyabe, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/713,394

(22) Filed: Feb. 26, 2010

Related U.S. Application Data
(63) Continuation of application No. PCT/JP2007/001032, filed on Sep. 21, 2007.

(51) Int. Cl. H04L 12/56

(52) U.S. Cl. 370/412

(57) ABSTRACT

In a label switching network using a plurality of labels including first and second labels, a communication apparatus receives a packet having the plurality of labels, and determines an output destination of the packet in accordance with the first label of the plurality of labels. Additionally, the communication apparatus sorts the packet to one of a plurality of packet queues in accordance with a combination of the first and the second labels of the plurality of labels, and reads and multiplexes packets from the plurality of packet queues.

### CROSS-REFERENCE TO RELATED APPLICATIONS

This application is a continuation application of International PCT Application No. PCT/JP2007/001032 which was filed on Sep. 21, 2007.

### FIELD

The embodiments discussed herein relate to a communication network and a communication apparatus which provide services by using packets each having a plurality of labels, such as a pseudo wire in a Multi Protocol Label Switching (MPLS) network.

### BACKGROUND

FIG. 1 illustrates an example of a communication network that provides services by using pseudo wires (for example, see Non-Patent Document 3) in an MPLS network (for example, see Non-Patent Documents 1 and 2). Edge devices 111 and 113 in the MPLS network 101 independently provide first and second users with a first service for terminal devices 114 and 116 of the first user and a second service for terminal devices 115 and 117 of the second user.

Initially, an MPLS tunnel 121 is generated between the edge devices 111 and 113 in order to provide a transmission path for a communication made between the edge devices 111 and 113. To generate/maintain the MPLS tunnel 121, a signaling message 131 for the MPLS tunnel is exchanged between the edge device 111 and a relay device 112, and a signaling message 132 for the MPLS tunnel is exchanged between the relay device 112 and the edge device 113.

Pseudo wires 122 and 123 are set within the transmission path, which is provided by the MPLS tunnel 121, respectively for the services in order to identify a service in the edge devices 111 and 113. To generate/maintain the pseudo wires 122 and 123, signaling messages 133 and 134 for the pseudo wires 122 and 123 are exchanged between the edge devices 111 and 113.

Signals (service flows 124 and 125) needed to provide the first and the second services are exchanged by using the pseudo wires 122 and 123, whereby these services are provided. Here, a signal needed to provide a service depends on the type of the service. For example, for an Ethernet (registered trademark) line service that provides a communication of a Media Access Control (MAC) frame of Ethernet (registered trademark) stipulated in the Institute of Electrical and Electronic Engineers (IEEE) 802.3, the MAC frame is information needed to provide the service.

FIG. 2 illustrates an example of a packet where service layer information is encapsulated in a pseudo wire and further encapsulated in an MPLS tunnel. In this example, the service is provided by using a plurality of labels (in two stages) composed of an MPLS tunnel label and a pseudo wire label.

The MPLS tunnel label is an identifier for identifying an MPLS tunnel and is used by the edge devices 111 and 113 and the relay device 112. The pseudo wire label is an identifier for identifying a pseudo wire and is used by only the edge devices 111 and 113. The service layer information is a signal needed to provide the above described services. This signal is, for example, a MAC frame in an Ethernet (registered trademark) line service. The services are provided by exchanging such packets between the edge devices 111 and 113.

In the meantime, it is desirable to multiplex a larger number of pseudo wires in one MPLS tunnel in order to provide a larger number of services in an MPLS network. The relay device forwards a packet by referring to only an MPLS tunnel label. Therefore, a forwarding table for MPLS tunnel labels which is to be held by the relay device is reduced in size by multiplexing pseudo wires. Moreover, the number of signaling messages for the MPLS tunnel which are to be processed by the relay device and the edge devices can be reduced.

The following Non-Patent Document 4 relates to Resource Reservation Protocol-Traffic Engineering (RSVP-TE) . Non-Patent Documents 5 and 6 relate to a Label Distribution Protocol (LDP) that is a signaling protocol for setting a pseudo wire. Non-Patent Document 7 relates to RSVP-TE Fast Reroute Extensions.

Non-Patent Document 1: Network Working Group Request for Comments 3031, January 2001

Non-Patent Document 2: Network Working Group Request for Comments 3032, January 2001

Non-Patent Document 3: Network Working Group Request for Comments 3985, March 2005

Non-Patent Document 4: Network Working Group Request for Comments 3209, December 2001

Non-Patent Document 5: Network Working Group Request for Comments 3036, January 2001

Non-Patent Document 6: Network Working Group Request for Comments 4447, April 2006

Non-Patent Document 7: Network Working Group Request for Comments 4090, May 2005

### SUMMARY

According to an aspect of the embodiment, a communication apparatus is a communication apparatus in a label switching network using a plurality of labels including first and second labels. The communication apparatus includes a receiving unit, a forwarding processing unit, a queuing processing unit, and a multiplexing unit.

The receiving unit receives a packet having a plurality of labels. The forwarding processing unit determines an output destination of the packet in accordance with the first label of the plurality of labels. The queuing processing unit sorts a packet to one of a plurality of packet queues in accordance with a combination of the first and the second labels of the plurality of labels. The multiplexing unit reads and multiplexes packets from the plurality of packet queues.

According to another aspect of the embodiment, a communication apparatus is a communication apparatus in a label switching network using a plurality of labels including first and second labels. This communication apparatus transmits, as signaling information for generating a label switching tunnel indicated by the first label, signaling information including a value of the second label to a relay device that relays a packet communication using the label switching tunnel, and further transmits a packet having the plurality of labels to the relay device.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 illustrates pseudo wires in a conventional MPLS network;

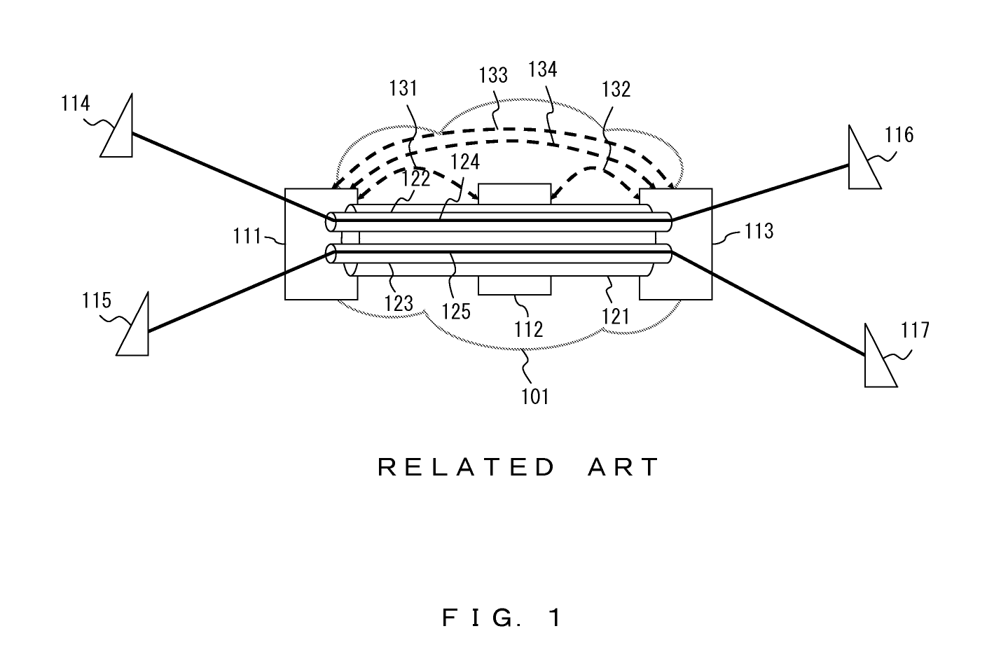

FIG. 2 illustrates a conventional packet having labels in two stages;

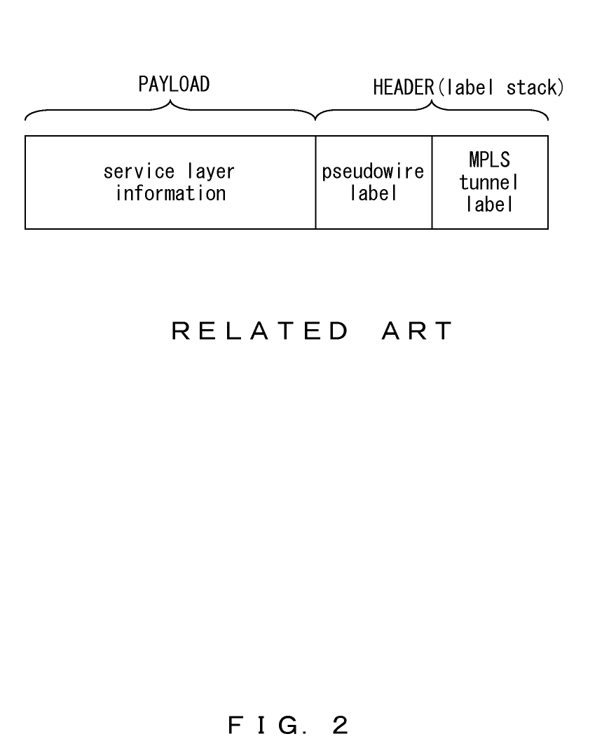

FIG. 3 illustrates a first queuing method;

FIG. 4 illustrates a second queuing method;

FIG. 5 illustrates a configuration of an MPLS communication system according to an embodiment;

FIG. 6 illustrates a configuration of an MPLS network according to the embodiment;

FIG. 7 illustrates a first RSVP-TE path message;

FIG. 8 illustrates a second RSVP-TE path message;

FIG. 9 illustrates a configuration of a relay device;

FIG. 10 illustrates a third RSVP-TE path message;

FIG. 11 illustrates a fourth RSVP-TE path message;

FIG. 12 illustrates a packet process using an individual queue and a common queue;

FIG. 13 illustrates a state before a fault occurs in Fast Reroute Extensions;

FIG. 14 illustrates a state after the fault occurs in the Fast Reroute Extensions;

FIG. 15 illustrates a packet having labels in three stages;

FIG. 16 illustrates a layered MPLS network;

FIG. 17 illustrates a fifth RSVP-TE path message; and

FIG. 18 illustrates a packet process using labels in three stages.

### DESCRIPTION OF EMBODIMENTS

The above described conventional MPLS network has the following problem.

If one of the users utilizing the same MPLS tunnel temporarily causes a large volume of traffic to flow, this can possibly exert influences such as a delay or the like on communications made by the other users.

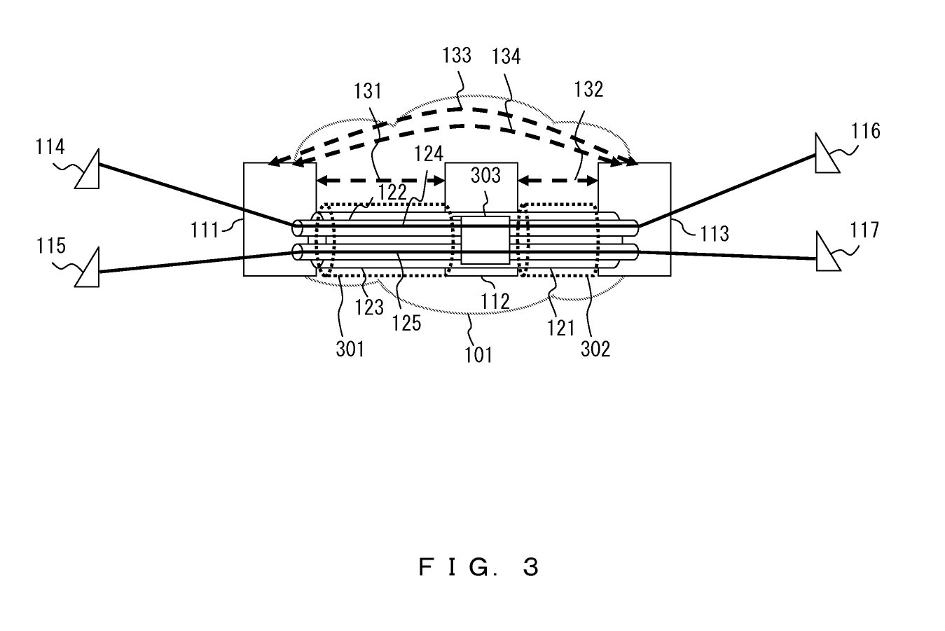

FIG. 3 illustrates an occurrence of such a communication delay. Assume that each committed information rate (CIR) and each peak information rate (PIR) for a communication made by each of the first and the second users is 40 Mbps and 80 Mbps, respectively. Here, the committed information rate is a bit rate that is continuously guaranteed during a communication, whereas the peak information rate is a bit rate at which packets can be transmitted while a communication network is idle. Also assume that a transmission rate (bandwidth) of a link 301 between the edge device 111 and the relay device 112 is 1 Gbps and a transmission rate of a link 302 between the relay device 112 and the edge device 113 is 100 Mbps.

Further assume that the first user causes a 70-Mbps service flow 124 to occur on a terminal device 114 and the second user causes a 40-Mbps service flow 125 to occur on a terminal device 115 in such a configuration.

The first user causes traffic to occur at a rate exceeding the committed information rate. However, since the traffic does not exceed the peak information rate, the entirety of the traffic is encapsulated by the pseudo wire 122 and the MPLS tunnel 121, and the encapsulated traffic is transmitted from the edge device 111. Because the traffic of the second user does not exceed the committed information rate, the entirety of the traffic is encapsulated by the pseudo wire 123 and the MPLS tunnel 121, and the encapsulated traffic is transmitted from the edge device 111.

The link 301 between the edge device 111 and the relay device 112 has a 1-Gbps bandwidth. Therefore, all traffic reaches the relay device 112 without any problems. The relay device 112 forwards this traffic to the edge device 113 by referring to an MPLS tunnel label. However, since the link 302 between the relay device 112 and the edge device 113 has a bandwidth as narrow as 100 Mbps, congestion occurs in the link 302, and part of the traffic of the first user, which exceeds the committed information rate, is discarded.

This control is implemented by assigning a higher discarding priority to a packet that exceeds the committed information rate among the packets of the traffic of the first user in the edge device 111, by transmitting this information along with an MPLS tunnel label, and by discarding a packet assigned a higher discarding priority in a device where congestion occurs.

However, the pseudo wires 122 and 123 of the first and the second users are multiplexed in the same MPLS tunnel 121, and they have an identical MPLS tunnel label. Accordingly, when the congestion occurs due to a large volume of traffic caused by the first user and a larger delay than a packet queue 303 of the relay device 112 occurs, a large delay also occurs in the traffic of the second user.

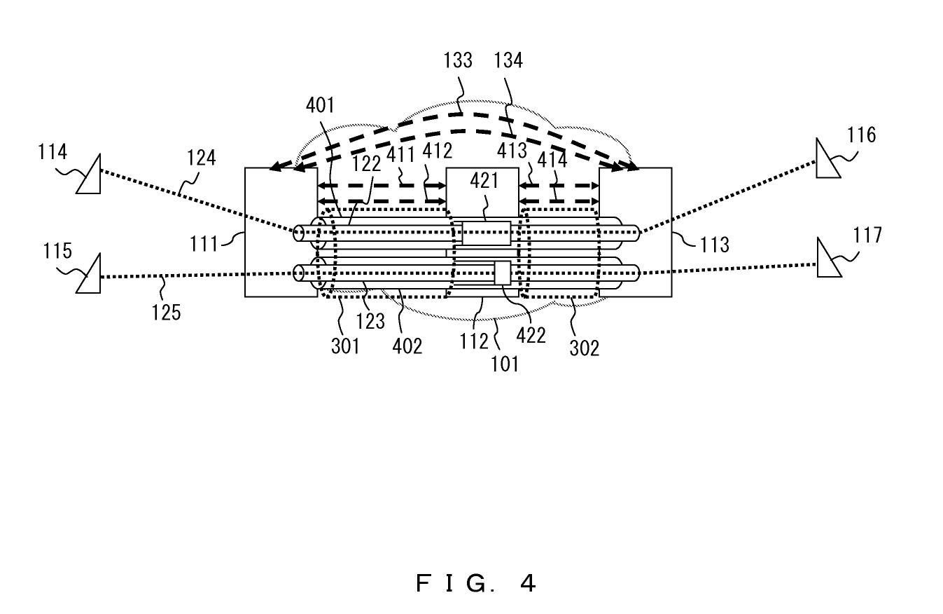

As a method overcoming such a problem, setting each MPLS tunnel for each pseudo wire as illustrated in FIG. 4 is considered. In this case, MPLS tunnels 401 and 402 are generated respectively for the pseudo wires 122 and 123, signaling messages 411 and 412 respectively for the MPLS tunnels are exchanged between the edge device 111 and the relay device 112, and signaling messages 413 and 414 respectively for the MPLS tunnels are exchanged between the relay device 112 and the edge device 113.

Here, assume that the committed information rate and the peak information rate of each of the MPLS tunnels 401 and 402 are 40 Mbps and 80 Mbps, respectively. Also assume that the committed information rate and the peak information rate for a communication made by each of the first and the second users are respectively 40 Mbps and 80 Mbps and that the transmission rates of the links 301 and 302 are respectively 1 Gbps and 100 Mbps, as in the case of FIG. 3.

The 70-Mbps service flow 124 of the first user and the 40-Mbps service flow 125 of the second user are forwarded to the edge device 113 via packet queues 421 and 422 of the relay device 112. Accordingly, the service flow 125 is not delayed by the congestion of the service flow 124. However, the number of MPLS tunnels that pass through the relay device 112 in the MPLS network 101 increases with this method, leading to an increase in the number of signaling sessions to be processed by the relay device 112 in comparison with the configuration illustrated in FIG. 3.

As described above, the relay device processes signaling sessions of MPLS tunnels by the number of services that the relay device itself relays. Therefore, a load imposed on the process for signaling messages is expected to be very heavy in the relay device that aggregates many edge devices. Accordingly, it is impossible to increase the number of services that can be accommodated in an MPLS network to a certain number or more.

Such a problem occurs not only in a communication network where a pseudo wire is encapsulated in an MPLS tunnel but also in a communication network where the second MPLS tunnel is encapsulated in the first MPLS tunnel.

Preferred embodiments of the present invention will be explained with reference to accompanying drawings.

It is desirable to assign a different queue to each service in a relay device in order to guarantee the communication quality of each service. However, it is desirable to carry a plurality of services through one MPLS tunnel in order to hold a load imposed on a signal process for the MPLS tunnel to a low level. As a method that simultaneously satisfies these two requirements, a method for notifying a relay device and an edge device at succeeding stages of an inner label value used by each of the services within a signaling message of an MPLS tunnel and for sorting, by the relay device, a packet to a corresponding queue on the basis of the notified label value is considered.

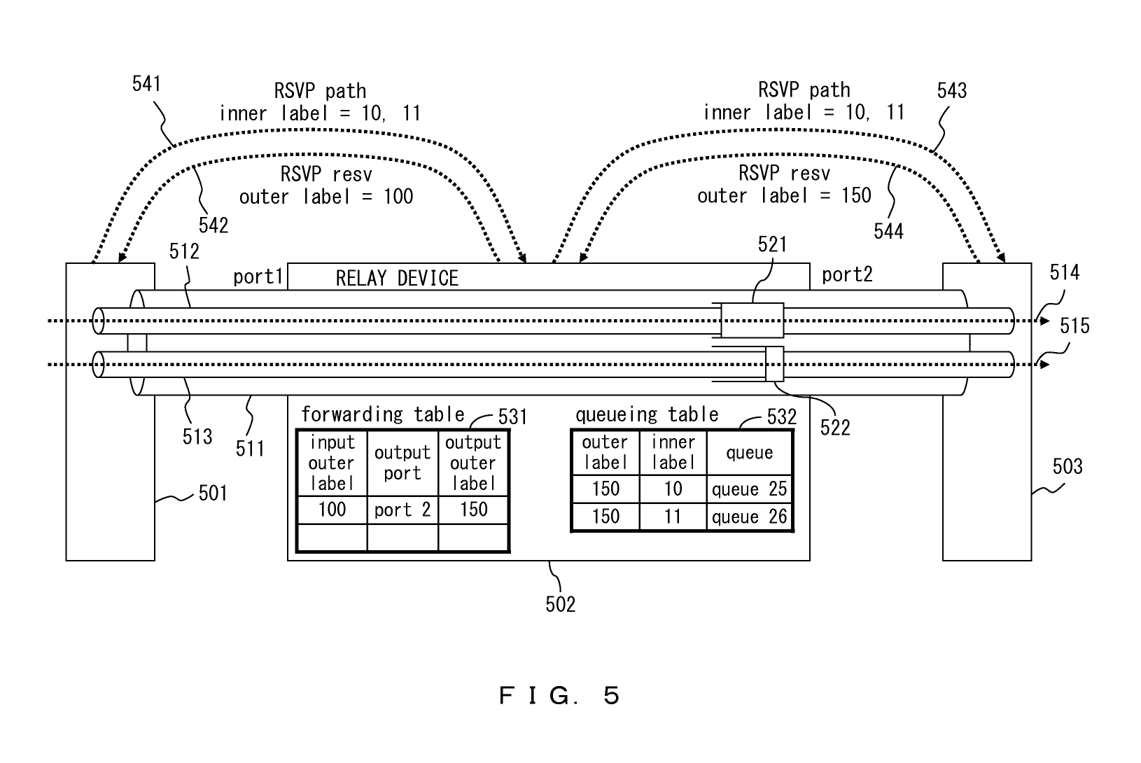

FIG. 5 illustrates an example of a configuration of such an MPLS communication system. This communication system includes edge devices 501 and 503, and a relay device 502. An MPLS tunnel 511 that goes through ports 1 and 2 of the relay device 502 is set between the edge devices 501 and 503. Additionally, a pseudo wire 512 for a service flow 514 of the first user and a pseudo wire 513 for a service flow 515 of the second user are set within the MPLS tunnel 511.

This example assumes that RSVP-TE is used for the signaling of the MPLS tunnel. This example also assumes that an MPLS tunnel label used between the edge device 501 and the relay device 502 is “100”, an MPLS tunnel label used between the relay device 502 and the edge device 503 is “150”, and pseudo wire labels of the pseudo wires 512 and 513 are respectively “10” and “11”.

The edge device 501 transmits an RSVP-TE path message 541 that is a signaling request of the MPLS tunnel 511 to the relay device 502, which then transmits an RSVP-TE path message 543 to the edge device 503. The values “10” and “11” of the pseudo wire labels transmitted through the MPLS tunnel 511 are reported within these messages. At this time, the values of the pseudo wire labels are reported using, for example, a method making the RSVP-TE path message include a new object.

The edge device 503 transmits an RSVP-TE resv message 544 to the relay device 502, which then transmits an RSVP-TE resv message 542 to the edge device 501.

Upon receipt of the path message 541 from the edge device 501 on an upstream side, the relay device 502 records the values “10” and “11” of the pseudo wire labels, which are reported with this message, and executes the same process as a process for a normal RSVP-TE path message.

Additionally, upon receipt of the resv message 544 from the edge device 503 on a downstream side, the relay device 502 generates a queuing table 532 on the basis of the value “150” of the MPLS tunnel label, which is reported with this message, and the recorded values “10” and “11” of the pseudo wire labels. An identifier of a corresponding queue is registered in the queuing table 532 for each combination of two values of an MPLS tunnel label and a pseudo wire label.

A packet is forwarded by using a forwarding table 531 that is generated on the basis of the values “100” and “150” of the MPLS tunnel labels, as in the conventional technology. At this time, the relay device 502 determines an output port of the packet in accordance with the value of a label in one stage at the beginning of the input packet, and rewrites the value of the label to the value of an output label. Moreover, the relay device 502 sorts the packet to a queue 521 or 522 by referring to the queuing table 532 in accordance with the values of labels in two stages at the beginning of the input packet.

With such a configuration, it is possible to provide a queue for each service accommodated in the same MPLS tunnel, whereby a delay quality of each service can be guaranteed without increasing the number of signaling sessions for the MPLS tunnel.

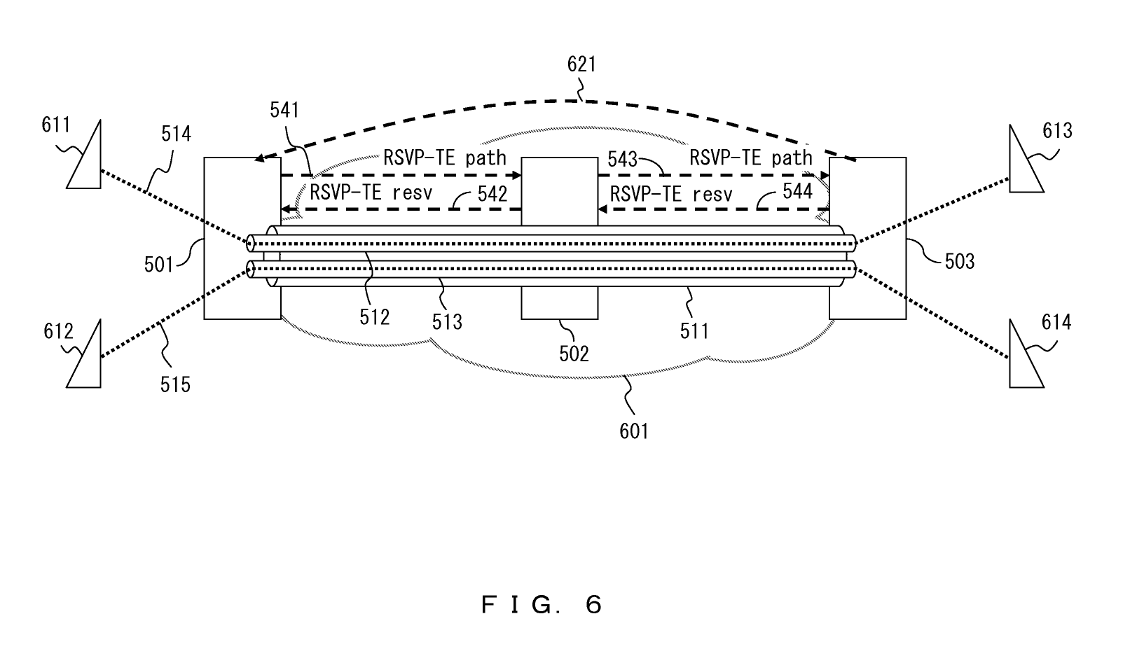

FIG. 6 illustrates an example of a configuration of an MPLS network including the MPLS communication system illustrated in FIG. 5. The edge devices 501 and 503 and the relay device 502 are arranged in the MPLS network 601. A terminal device 611 of the first user and a terminal device 612 of the second user are connected to the edge device 501, whereas a terminal device 613 of the first user and a terminal device 614 of the second user are connected to the edge device 503. Operations of the communication system are described below by using label values different from those of the MPLS tunnel labels and the pseudo wire labels given in FIG. 5.

A state where only the pseudo wire 512 and not the pseudo wire 513 is set is considered as a first state. In this state, RSVP-TE path/resv messages 541 to 544 are exchanged between the edge device 501, the relay device 502 and the edge device 503, and the MPLS tunnel 511 heading from the edge device 501 to the edge device 503 is set.

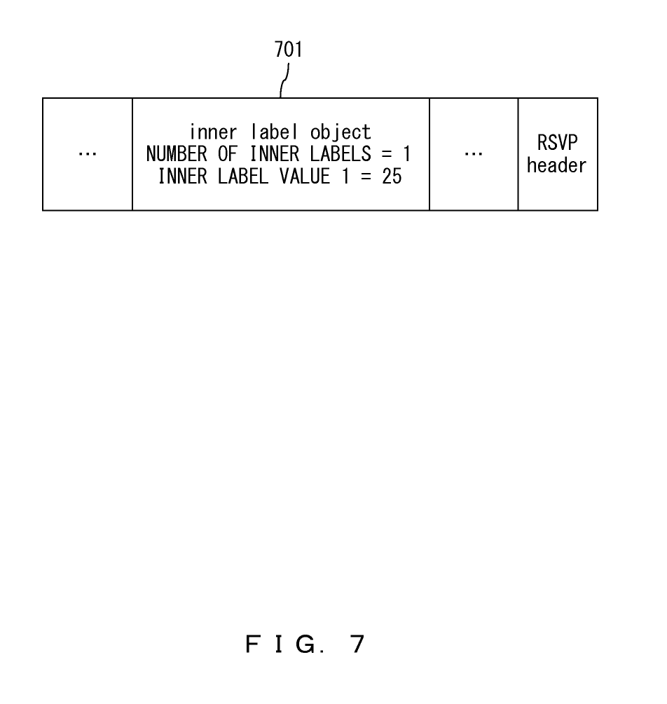

FIG. 7 schematically illustrates an example of the RSVP-TE path message 541 transmitted from the edge device 501. An inner label object 701 includes settings such that the number of inner labels corresponding to pseudo wire labels is “1” and the value of an inner label corresponding to the pseudo wire 512 is “25”.

In this state, assume that an LDP label mapping message 621 is exchanged between the edge devices 501 and 503 and that the value of the pseudo wire label corresponding to the pseudo wire 513 is fixed to “20”. At this time, the edge device 501 makes the RSVP-TE path message 541 include the value “20” of the pseudo wire label corresponding to the pseudo wire 513 in order to notify the relay device 502 that the pseudo wire 513 is also transmitted through the MPLS tunnel 511.

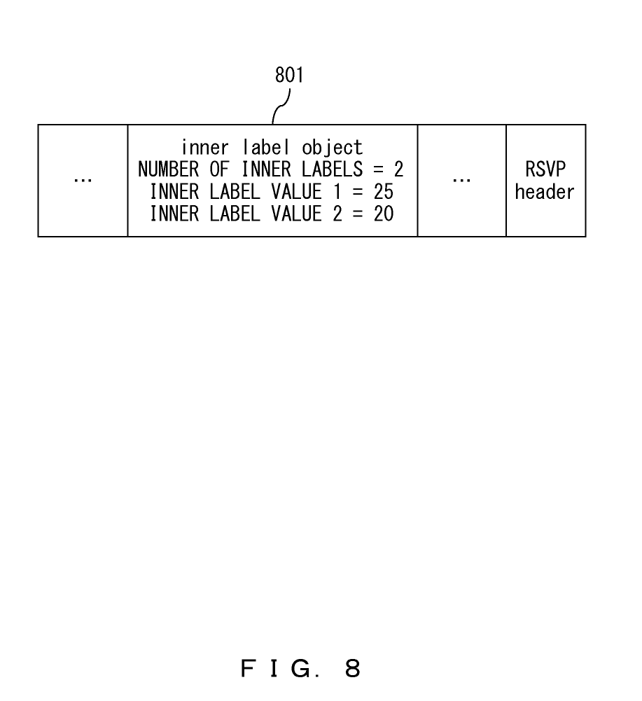

FIG. 8 illustrates an example of the RSVP-TE path message 541. An inner label object 801 includes settings such that the number of inner labels is “2” and the values of inner labels corresponding to the pseudo wires 512 and 513 are respectively “25” and “20”.

At this time, the content of signaling messages for the MPLS tunnel 511 varies. Therefore, make-before-break procedures referred to in section 2.5 of Non-Patent Document 4 are used.

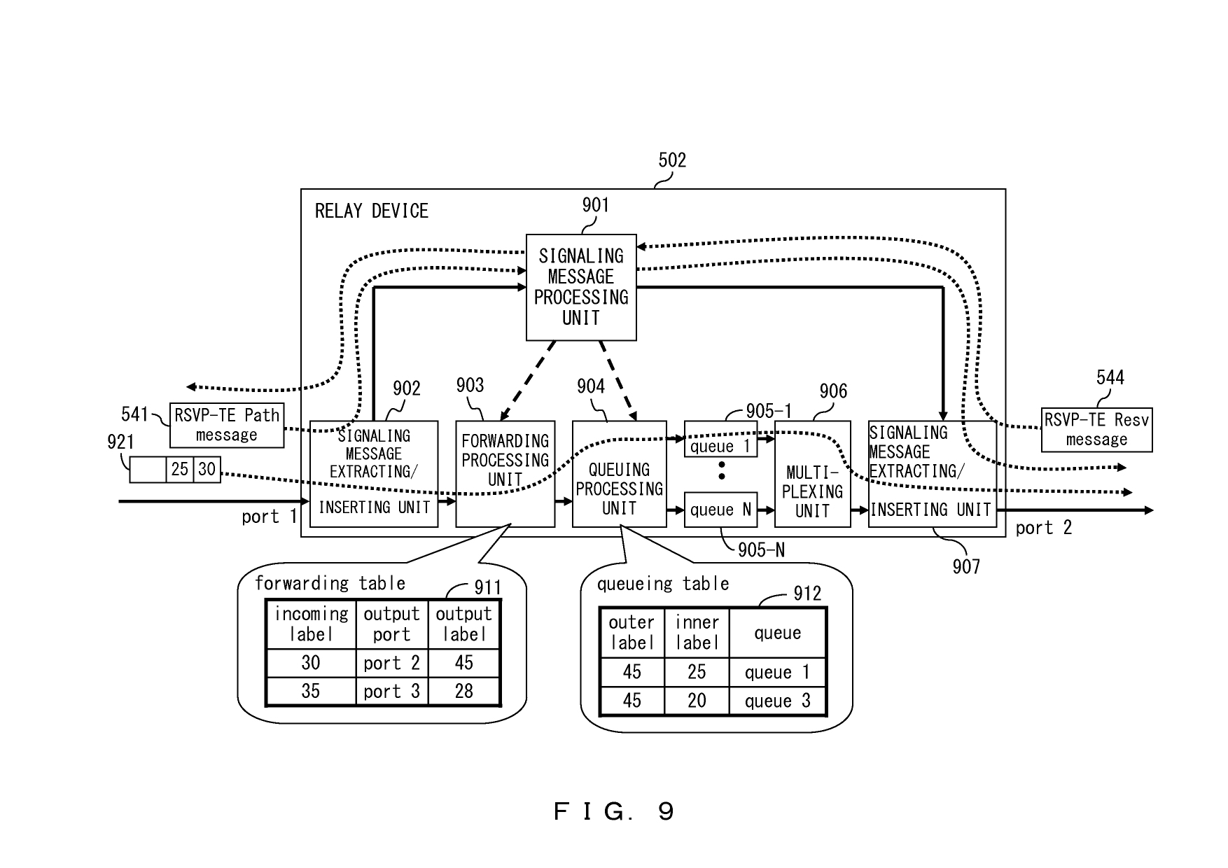

FIG. 9 illustrates an example of a configuration of the relay device 502. This relay device 502 includes a signaling message processing unit 901, signaling message extracting/inserting units 902 and 907, a forwarding processing unit 903, a queuing processing unit 904, queues 905-1 to 905-N, and a multiplexing unit 906. Identifiers of the queues 905-1 to 905-N are “queue1” to “queueN”, respectively.

The path message 541 is received by the port 1, and transferred to the signaling message processing unit 901 via the signaling message extracting/inserting unit 902. The resv message 544 is received by the port 2, and transferred to the signaling message processing unit 901 via the signaling message extracting/inserting unit 907.

The signaling message processing unit 901 generates a forwarding table 911 by processing these signaling messages, and sets the generated forwarding table 911 in the forwarding processing unit 903. A combination of an identifier of an output port and an output label value are registered to the forwarding table 911 for each input label value.

Additionally, the signaling message processing unit 901 generates a queuing table 912 by using the value “45” of the MPLS tunnel label, which is reported with the resv message 544, and the values “25” and “20” of the pseudo wire labels, which are set in the inner label object of the path message 541, and sets the generated queuing table 912 in the queuing processing unit 904. An identifier of a queue is registered to the queuing table 912 for each combination of an outer label value that indicates the value of an MPLS tunnel label and an inner label value that indicates the value of a pseudo wire label.

When the port 1 receives a packet 921 having a label stack composed of labels in two stages after these tables are set, the packet 921 is transferred to the forwarding processing unit 903 via the signaling message extracting/inserting unit 902.

The forwarding processing unit 903 forwards the packet by referring to the forwarding table 911. For example, if the value of the outermost label (outer label value) in the label stack of the packet 921 is “30”, the label value is rewritten to “45” in accordance with the forwarding table 911, and the packet 921 is transferred to the queuing processing unit 904 corresponding to the port 2.

The queuing processing unit 904 sorts the packet to one of the queues 905-1 to 905-N in accordance with the queuing table 912. In this example, the value of the outer label in the label stack is “45”, and the value of the inner label is “25”. Therefore, this packet is sorted to the queue 905-1 corresponding to “queue1”.

The multiplexing unit 906 multiplexes packets output from the queues 905-1 to 905-N, and outputs the multiplexed packet to the port 2 via the signaling message extracting/inserting unit 907.

Another example of operations of the MPLS communication system illustrated in FIG. 6 is described next. In this operational example, whether or not an individual queue is needed and bandwidth information are added as pseudo wire information set in a signaling message.

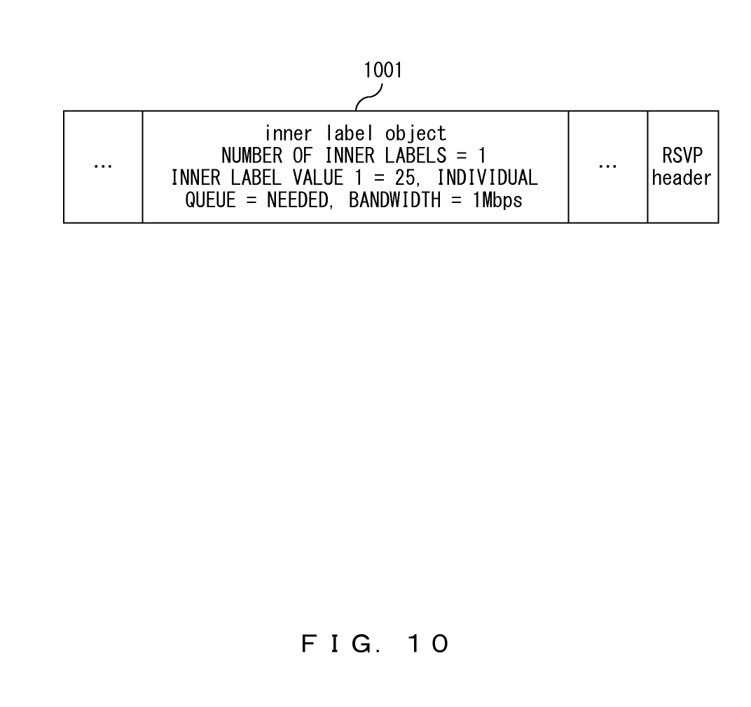

FIG. 10 illustrates an example of the RSVP-TE path message 541 in a state where only the pseudo wire 512 is set. An inner label object 1001 includes settings such that the number of inner labels is “1”, the value of an inner label corresponding to the pseudo wire 512 is “25”, whether or not an individual queue is needed is “needed”, and a bandwidth is “1 Mbps”.

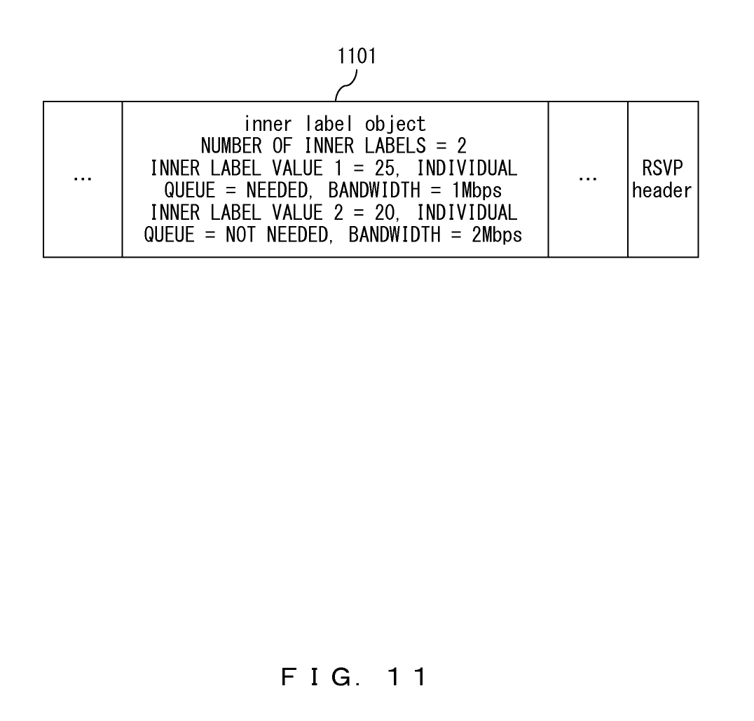

FIG. 11 illustrates an example of the RSVP-TE path message 541 in a state where the pseudo wires 512 and 513 are set. An inner label object 1101 includes settings such that the number of inner labels is “2”, the values set for the pseudo wire 512 illustrated in FIG. 10 are included, the value of an inner label corresponding to the pseudo wire 513 is “20”, whether or not an individual queue is needed for the pseudo wire 513 is “not needed”, and a bandwidth for the pseudo wire 513 is “2 Mbps”.

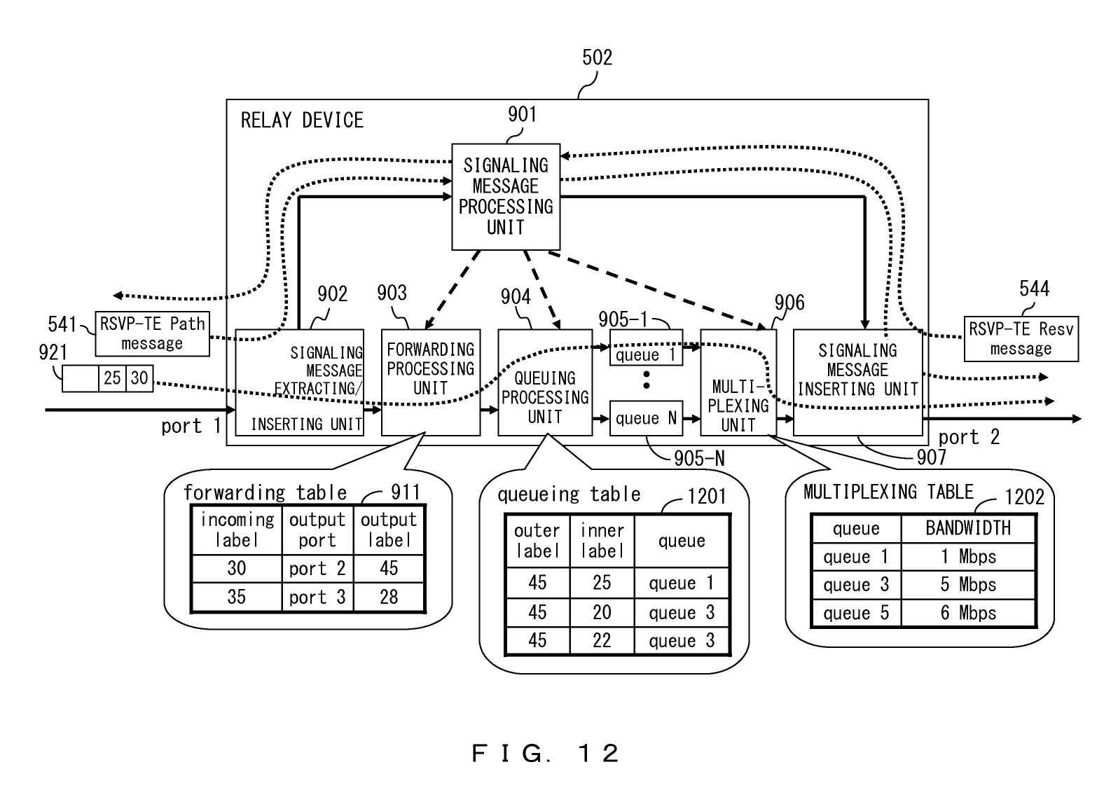

As illustrated in FIG. 12, the signaling message processing unit 901 of the relay device 502 refers to the information of whether or not an individual queue is needed set in the path message 541 and generates a queuing table 1201 with which only a packet of a pseudo wire that needs an individual queue is sorted to an individual queue and other packets are sorted collectively to a common queue.

In this example, a packet having outer and inner label values that are respectively “45” and “25” is sorted to the individual queue 905-1 corresponding to “queue1”. In the meantime, a packet having outer and inner label values that are respectively “45” and “20”, and a packet having outer and inner label values that are respectively “45” and “22” are sorted to the common queue 905-3 corresponding to “queue3”.

Furthermore, the signaling message processing unit 901 generates a multiplexing table 1202 by using a bandwidth set in the inner label object of the path message 541, and sets the generated multiplexing table 1202 in the multiplexing unit 906. A read rate (bandwidth) is registered to the multiplexing table 1202 for each queue identifier. At this time, a bandwidth of “1 Mbps” set in the path message 541 is set for “queue1”, and a bandwidth of “5 Mbps” of the common queue is set for “queue3”.

The multiplexing unit 906 reads a packet accommodated in each queue at a rate proportional to the bandwidth of a pseudo wire while referring to the multiplexing table 1202, multiplexes the read packets, and transfers the multiplexed packet to the signaling message extracting/inserting unit 907.

The above described embodiment refers to the control performed when a pseudo wire is encapsulated in an MPLS tunnel. However, a similar control is applicable also to a case where a second MPLS tunnel is encapsulated in a first MPLS tunnel.

In this case, the second MPLS tunnel is nested in the first MPLS tunnel, and is transmitted through the first MPLS tunnel. Examples of the nesting of an MPLS tunnel include a case where a Fast Reroute Extensions, referred to in Non-Patent Document 7, is used, and a case where an MPLS network is layered in order to improve scalability.

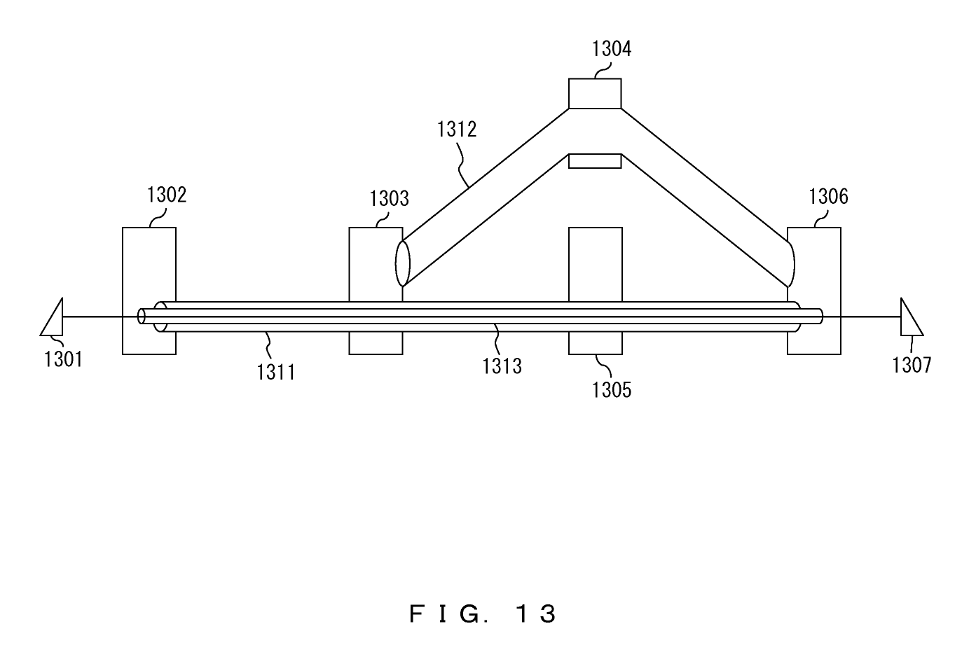

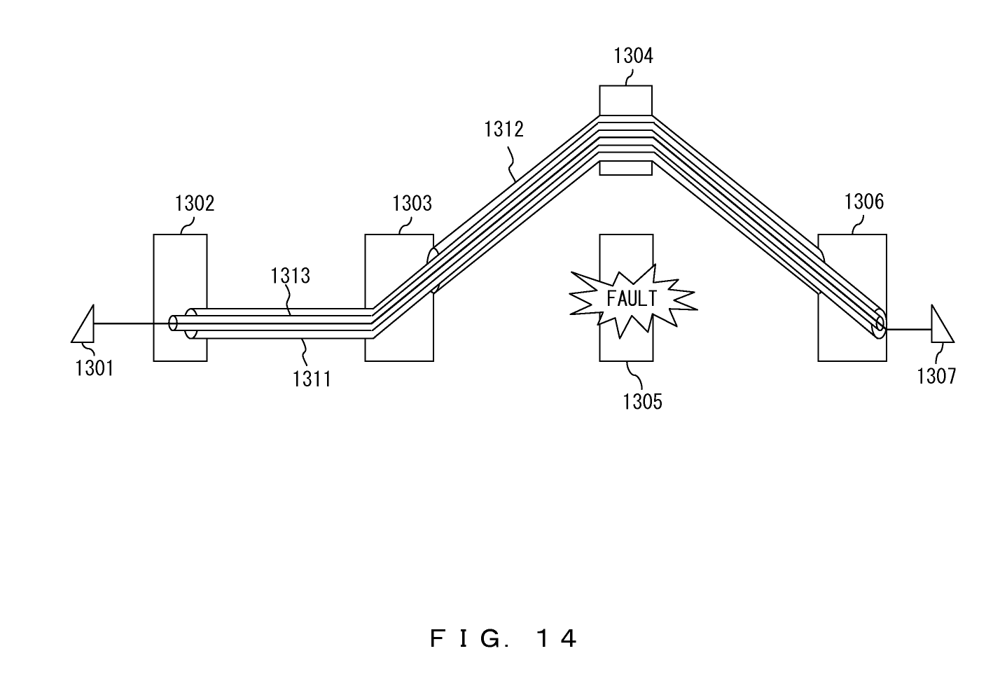

The case of FRR is described first. FIGS. 13 and 14 respectively illustrate states before and after a fault occurs when the facility backup of FRR is used.

An MPLS tunnel 1311 that goes through relay devices 1303 and 1305 is set between edge devices 1302 and 1306 before a fault occurs . Within the MPLS tunnel 1311, a pseudo wire 1313 for a service flow between terminal devices 1301 and 1307 of a user is set. Moreover, another MPLS tunnel 1312 that goes through a relay device 1304 is set to bypass the fault that has occurred in a section between the relay device 1303 and the edge device 1306.

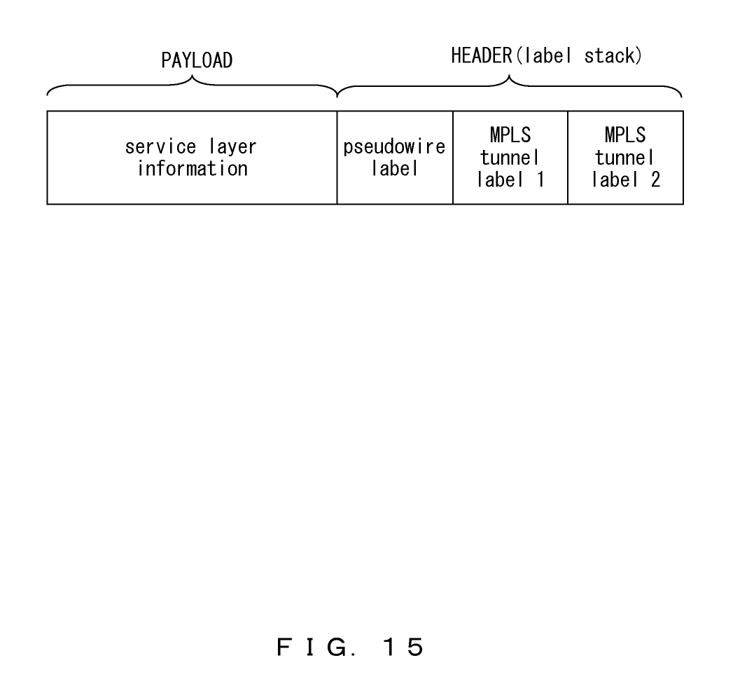

If the fault occurs in the relay device 1305 in this state, the MPLS tunnel 1311 is transmitted through the MPLS tunnel 1312 as illustrated in FIG. 14 in order to bypass the fault. Thereafter, a packet having labels in a total of three stages composed of MPLS tunnel labels in two stages and a pseudo wire label in one stage is transmitted between the relay device 1303 and the edge device 1306 as illustrated in FIG. 15.

The case where an MPLS network is layered is described next. Layering of the MPLS network is used, for example, to improve scalability or the like by reducing a load imposed on a signaling or forwarding process in a core portion of the MPLS network with a transmission of a plurality of MPLS tunnels through one MPLS tunnel in the core portion.

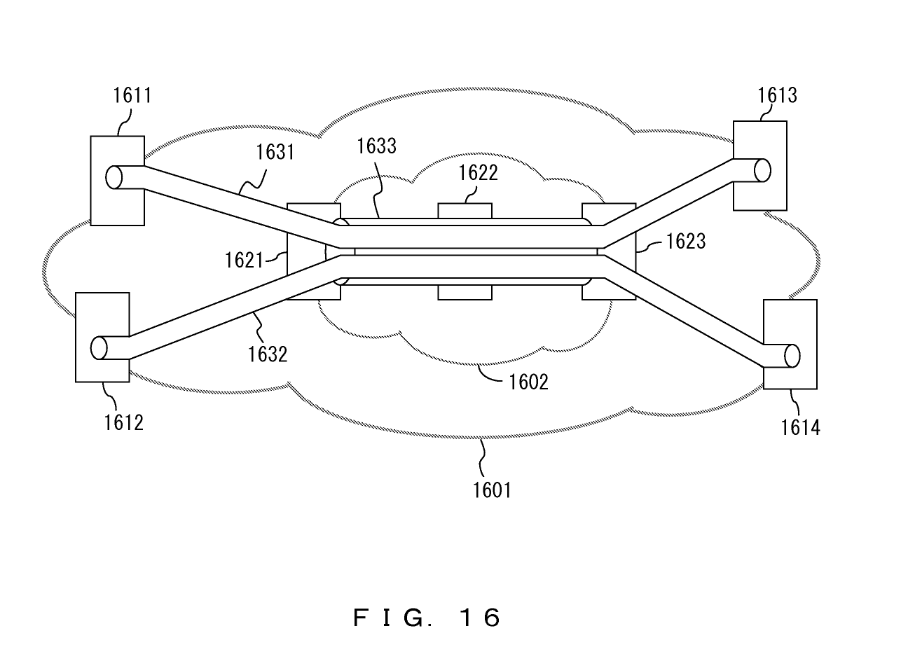

FIG. 16 illustrates an example of an MPLS network put into two layers. In an MPLS network 1601 in the first layer, edge devices 1611 to 1614 in the first layer are arranged, and an MPLS network 1602 in the second layer is included. In the MPLS network 1602, edge devices 1621 and 1623 in the second layer and a relay device 1622 in the second layer are arranged.

An MPLS tunnel 1633 that goes through the relay device 1622 is set between the edge devices 1621 and 1623. Moreover, an MPLS tunnel 1631 that goes through the MPLS tunnel 1633 is set between the edge devices 1611 and 1613, and an MPLS tunnel 1632 that goes through the MPLS tunnel 1633 is set between the edge devices 1612 and 1614.

In this example, the MPLS tunnel 1633 is set in the MPLS network 1602, and the MPLS tunnels 1631 and 1632 in the MPLS network 1601 are transmitted through the MPLS tunnel 1633. Accordingly, the relay device 1622 needs to process neither the signaling of the MPLS tunnels 1631 and 1632 nor an individual forwarding process for these MPLS tunnels.

For example, if a pseudo wire is further transmitted through the MPLS tunnel 1631, a packet that passes through the MPLS network 1602 has labels in three stages as illustrated in FIG. 15. FIG. 16 illustrates the network configuration of two layers. However, a similar control is similarly applicable to a network configuration of three layers or more.

If the number of labels is three or more, it is desirable to notify a relay device of the values of inner labels in two stages or more by using an inner label object within an RSVP-TE path message in order to guarantee the communication quality of each service. The relay device sorts a packet to a queue by referring to the labels in three stages or more on the basis of the reported information.

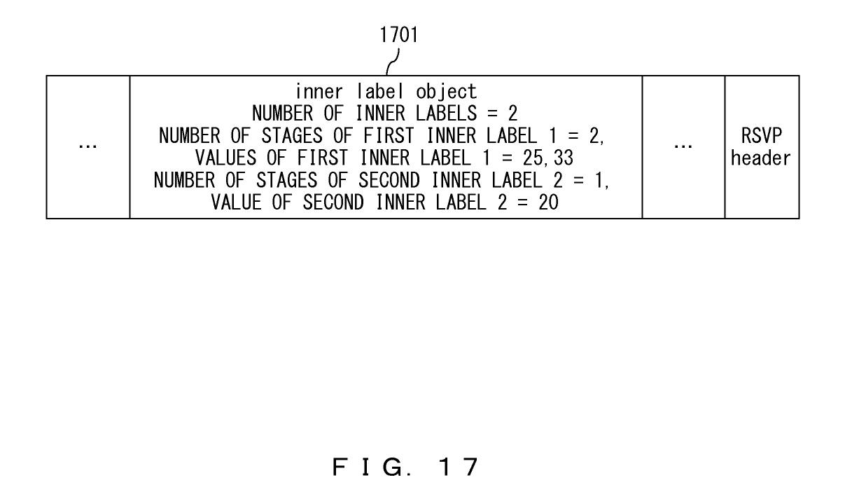

FIG. 17 illustrates an example of an RSVP-TE path message including an inner label object for reporting the values of inner labels in two stages. The inner label object 1701 includes settings such that the number of inner labels is “2”, the first inner label is composed of the values “25” and “33” of labels in two stages, and the second inner label is composed of the value “20” of a label in one stage.

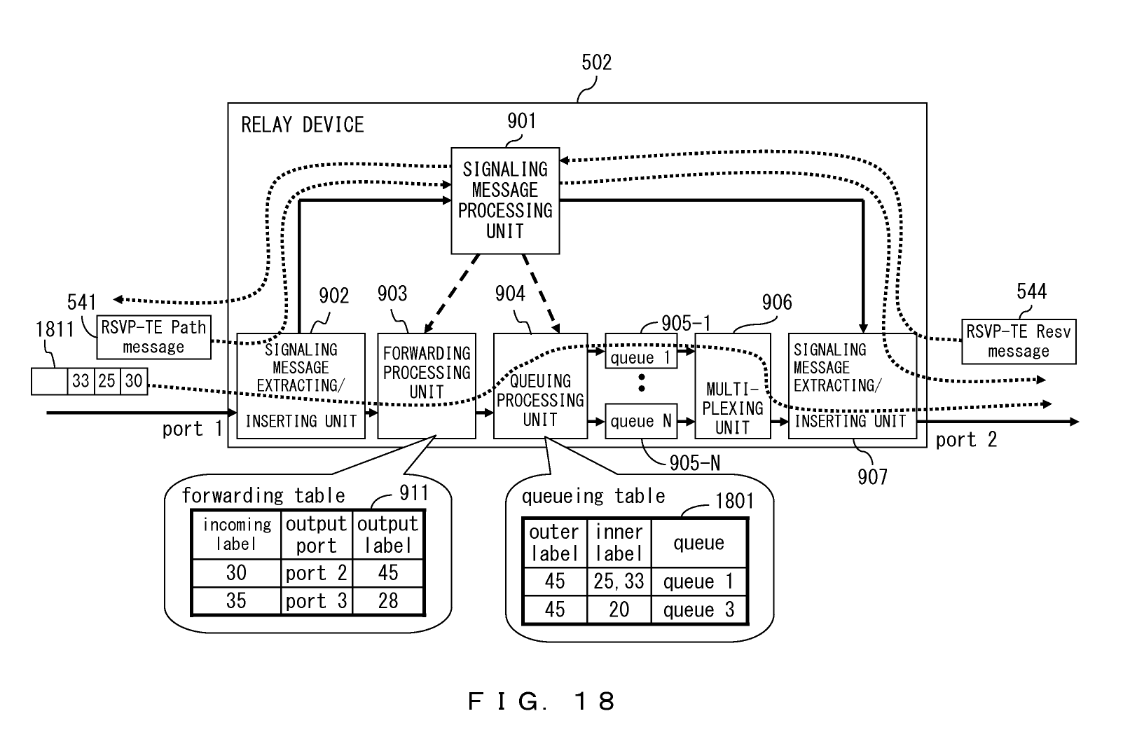

As illustrated in FIG. 18, the signaling message processing unit 901 of the relay device 502 generates a queuing table 1801 in accordance with the configuration of inner labels set in the path message 541. An inner label in the queuing table 1801 corresponds to one or a plurality of labels. The queuing processing unit 904 sorts a packet to a queue by referring to labels in two or three stages including an outer label.

In this example, a packet having an outer label value of “45” and inner label values of “25” and “33” is sorted to the queue 905-1 corresponding to “queue1”. In the meantime, a packet having an outer label value of “45” and an inner label value of “20” is sorted to the queue 905-3 corresponding to “queue3”.

For example, the outer label value of a packet 1811 is “30”. Therefore, the label value is rewritten to “45” in accordance with the forwarding table 911, and the packet is transferred to the queuing processing unit 904. The outer label value of the transferred packet is “45” and its inner label values are “25” and “33”. Therefore, this packet is sorted to the queue 905-1.

Also, when labels in three or more stages are used, it is possible to add whether or not an individual queue is needed and to add bandwidth information as pseudo wire information set in a signaling message, as illustrated in FIGS. 10 to 12.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus in a label switching network using a plurality of labels including first and second labels, the communication apparatus comprising:
a receiving unit configured to receive a packet including the plurality of labels;
a forwarding processing unit configured to determine an output destination of the packet in accordance with the first label of the plurality of labels;
a queuing processing unit configured to sort the packet to one of a plurality of packet queues in accordance with a combination of the first and the second labels of the plurality of labels; and
a multiplexing unit configured to read and multiplex packets from the plurality of packet queues.

2. The communication apparatus according to claim 1, further comprising
a signaling message processing unit configured to receive, as signaling information for generating a label switching tunnel indicated by the first label, first signaling information including a value of the first label and second signaling information including a value of the second label, and to generate a queuing table to which the combination of the first and the second labels and identification information of a sorting destination queue are registered, wherein
the queuing processing unit determines a sorting destination queue of the packet by referring to the generated queuing table.

3. The communication apparatus according to claim 2, wherein
the second signaling information includes information indicating whether or not an individual queue is needed for each second label, and
the signaling message processing unit generates a queuing table where a second label is made to correspond to an individual queue if the individual queue is needed and the second label is made to correspond to a common queue if the individual queue is not needed.

4. The communication apparatus according to claim 2, wherein
the second signaling information includes bandwidth information of each second label,
the signaling message processing unit generates a multiplexing table to which the identification information of the sorting destination queue and bandwidth information are registered, and
the multiplexing unit reads the packets from the plurality of packet queues in accordance with the bandwidth information registered to the generated multiplexing table.

5. The communication apparatus according to claim 2, wherein
the first label is a tunnel label of the label switching tunnel, and
the second label is a pseudo wire label of a pseudo wire generated within the label switching tunnel or a tunnel label of another label switching tunnel generated within the label switching tunnel.

6. A communication apparatus in a label switching network using a plurality of labels including first and second labels, wherein
the communication apparatus transmits, as signaling information for generating a label switching tunnel indicated by the first label, signaling information including a value of the second label to a relay device that relays a packet communication using the label switching tunnel, and further transmits a packet having the plurality of labels to the relay device.

7. The communication apparatus according to claim 6, wherein
the first label is a tunnel label of the label switching tunnel, and
the second label is a pseudo wire label of a pseudo wire generated within the label switching tunnel or a tunnel label of another label switching tunnel generated within the label switching tunnel.

8. A communication method for use in a label switching network using a plurality of labels including first and second labels, comprising:
receiving a packet having the plurality of labels;
determining an output destination of the packet in accordance with the first label of the plurality of labels;
sorting the packet to one of a plurality of packet queues in accordance with a combination of the first and the second labels of the plurality of labels;
reading and multiplexing packets from the plurality of packet queues; and
transmitting a multiplexed packet to the output destination.

9. The communication method according to claim 8, further comprising:
receiving, as signaling information for generating a label switching tunnel indicated by the first label, first signaling information including a value of the first label and second signaling information including a value of the second label; and
generating a queuing table to which the combination of the first and the second labels and identification information of a sorting destination queue are registered, wherein
the sorting determines a sorting destination queue of the packet by referring to the generated queuing table.

10. The communication method according to claim 9, wherein
the second signaling information includes information indicating whether or not an individual queue is needed for each second label, and
the generating the queuing table generates a queuing table where a second label is made to correspond to an individual queue if the individual queue is needed and the second label is made to correspond to a common queue if the individual queue is not needed.

11. The communication method according to claim 9, wherein
the second signaling information includes bandwidth information of each second label,
the communication method further comprising generating a multiplexing table to which the identification information of the sorting destination queue and bandwidth information are registered, and
the reading and multiplexing reads the packets from the plurality of packet queues in accordance with the bandwidth information registered to the generated multiplexing table.

12. The communication method according to claim 9, wherein
the first label is a tunnel label of the label switching tunnel, and
the second label is a pseudo wire label of a pseudo wire generated within the label switching tunnel or a tunnel label of another label switching tunnel generated within the label switching tunnel.
